(19) United States
(12) Patent Application Publication
(10) Pub. No.: US 2019/0072087 A1
(43) Pub. Date: Mar. 7, 2019

(54) GEAR PUMP AND METHOD FOR MONITORING A GEAR PUMP

(71) Applicant: BESTSENS AG, Coburg (DE)

(72) Inventor: Wolfgang DILLER, Coburg (DE)

(73) Assignee: BESTSENS AG, Coburg (DE)

(21) Appl. No.: 16/081,505

(22) PCT Filed: Feb. 27, 2017
(86) PCT No.: PCT/EP2017/054471

§ 371 Date: Aug. 31, 2018

(30) Foreign Application Priority Data
Mar. 2, 2016 (DE) 10 2016 203 425.1

(51) Int. Cl. F04B 51/00; F04C 14/28; G01N 29/07; G01N 29/11

(52) U.S. Cl. CPC F04B 51/00; F04C 14/28; F04C 2/084; G01N 29/11; G01N 29/07

(57) ABSTRACT

A gear pump includes at least a first and a second rotatable element, wherein the first rotatable element has a toothing system which interacts with a toothing system of the second rotatable element. The gear pump further includes a housing in which the first and/or the second rotatable element are at least partially arranged, and at least one transmitter, which is arranged on the housing, for exciting acoustic waves in the housing. At least one receiver is arranged on the housing, for receiving the acoustic waves which are excited in the housing. Information about properties of the gear pump and/or of a pumping medium can be determined by evaluating a signal which is generated by the receiver when the acoustic waves are received.

### CROSS-REFERENCE TO A RELATED APPLICATION

This application is a National Phase patent application of International Patent Application Number PCT/EP2017/054471, filed on Feb. 27, 2017, which claims priority of German Patent Application 10 2016 203 425.1, filed on Mar. 2, 2016.

### BACKGROUND

The invention relates to a gear pump and also to a method for monitoring a gear pump.

Gear pumps, in particular in the form of screw-spindle pumps, serve in particular to convey liquids in the manner of a positive-displacement pump. A gear pump has, for example, at least two interacting gears, wherein the medium to be conveyed is moved into conveying chambers which are present between toothing systems of the gears and a housing of the gear pump. It is difficult to ascertain information about their current state (for example about the state of a lubricating film) and/or the conveyed medium (pumping medium) during operation of gear pumps.

### SUMMARY

A problem on which the invention is based is therefore that of being able to determine information relating to the gear pump and/or the pumping medium during operation.

This problem is solved by the gear pump having features as described herein and also by the method having features as described herein.

Accordingly, a gear pump is provided, comprising
at least a first and a second rotatable element, wherein
the first rotatable element has a toothing system which interacts with a toothing system of the second rotatable element; and
a housing in which the first and/or the second rotatable element are at least partially arranged; and
at least one transmitter, which is arranged on the housing, for exciting acoustic waves in the housing and also at least one receiver, which is arranged on the housing, for receiving the acoustic waves which are excited in the housing, wherein information about properties of the gear pump and/or of a pumping medium can be determined by evaluating a signal (an electrical signal) which is generated by the receiver when the acoustic waves are received.

The gear pump according to the invention may be of any desired design in principle. For example, the rotatable elements are each designed in the form of a gear, as a result of which an external or internal gear pump can be realized for example.

It is also feasible that the toothing systems of the first and of the second rotatable element run obliquely in relation to the respective rotation axis. For example, the first and the second rotatable element are designed in the manner of a screw spindle here, so that a gear pump in the form of a screw-spindle pump is realized. The toothing systems of the first and of the second rotatable element of a screw-spindle pump of this kind are then each designed in the manner of a threaded profile (in particular in the manner of an external thread). It is of course feasible in particular that there are more than two rotatable elements. Gear pumps, in particular screw-spindle pumps, are known in principle from the prior art, and therefore details of these pumps will not be discussed further.

The transmitter is designed, in particular, such that it can excite acoustic surface waves (for example in the form of Lamb waves or Lamb-Rayleigh waves) in the housing, said waves propagating from the transmitter to the receiver. For example, the transmitter (and for example also the receiver) is arranged on the housing (for example in a recess in the housing, for example in each case in a bore) such that surface sound waves are excited, which surface sound waves propagate on an inner side of the housing which faces the first and/or second rotatable element. The frequency of the surface waves is selected, in particular, depending on the thickness of the housing; for example, excitation frequencies in the range of between 500 kHz and 2 MHz or in the range of between 800 kHz and 1.5 MHz are used. The transmitter and/or the receiver are/is designed, in particular, in the form of a piezo converter or an interdigital transducer.

Furthermore, the transmitter and the receiver are arranged, for example, along a line which runs in relation to the rotation axis of the first or of the second rotatable element, that is to say the transmitter and receiver are positioned in an axial direction with respect to the rotatable element. In particular, the transmitter and the receiver are associated with the same one of the at least two rotatable elements, wherein the transmitter and the receiver can be oriented, for example, parallel in relation to one another (for example in a radial direction) with respect to this rotatable element. It is feasible that the transmitter and receiver are oriented horizontally, that is to say along one plane in which both the rotation axis of the first rotatable element and also the rotation axis of the second rotatable element lie, or vertically, that is to say perpendicular in relation to said plane.

The transmitter and the receiver are arranged, in particular, at an axial distance from one another which amounts to at least half the pitch of the profile (that is to say the distance of two profile maxima from one another) of the first or of the second rotatable element. However, it is also possible that the transmitter and receiver are arranged at a smaller distance from one another.

According to another refinement of the invention, the transmitter and the receiver are not arranged axially in relation to one another, but rather radially. For example, the transmitter is oriented in a first radial direction and the receiver is oriented in a second radial direction, which differs from the first radial direction, with respect to the first or the second rotatable element, that is to say the transmitter and the receiver are associated with the same rotatable element, but are oriented at an angle in relation to one another.

The invention also relates to a method for monitoring a gear pump, in particular a gear pump as described above, comprising the steps of:
providing at least a first and a second rotatable element, wherein the first rotatable element has a toothing system which interacts with a toothing system of the second rotatable element, and wherein the first and/or the second rotatable element are at least partially arranged in a housing; and
exciting acoustic waves in the housing by way of at least one transmitter which is arranged on the housing, and receiving the acoustic waves, which are excited in the housing, by way of a receiver which is arranged on the housing, and also determining information about properties of the gear pump and/or of a pumping medium by evaluating a signal which is generated by the receiver when the acoustic waves are received.

For example, information relating to a lubricating film (or the lubricating gap between the rotating element and the housing), a load which acts on the first and/or second rotatable element and/or a movement of the first or of the second rotatable element are determined and/or a defect in the first or in the second rotatable element is detected by evaluating the signal from the receiver during operation of the gear pump.

It is possible that evaluating the signal from the receiver comprises evaluating an amplitude, a frequency spectrum and/or an envelope of the signal and/or of a time interval of structures in the signal. For example, evaluating the receiver signal also comprises identifying patterns in the profile of the receiver signal.

According to another exemplary embodiment of the invention, pulsed acoustic waves are excited in the housing, wherein evaluating the receiver signal comprises ascertaining propagation times and/or amplitudes of the pulsed acoustic waves during operation of the gear pump. The propagation times periodically fluctuate, for example during operation of the gear pump, wherein information about properties of the gear pump and/or the pumping medium can be ascertained on the basis of the amplitude and/or the frequency of the fluctuations in the propagation times.

### BRIEF DESCRIPTION OF THE DRAWINGS

The invention will be explained in more detail below on the basis of exemplary embodiments with reference to the figures.

FIG. 1 shows a perspective view of a screw-spindle pump according to one exemplary embodiment of the invention.

FIGS. 2A, 2B show states of the screw-spindle pump from FIG. 1 during its operation.

FIG. 3 shows propagation times of acoustic pulses during operation of the screw-spindle pump from FIG. 1.

FIG. 4 shows the change in the pulse propagation times over the measurement period.

FIG. 5 shows a perspective view of a screw-spindle pump according to a second exemplary embodiment of the invention.

FIG. 6 shows a sectional illustration through a screw-spindle pump according to a third exemplary embodiment of the invention.

### DETAILED DESCRIPTION

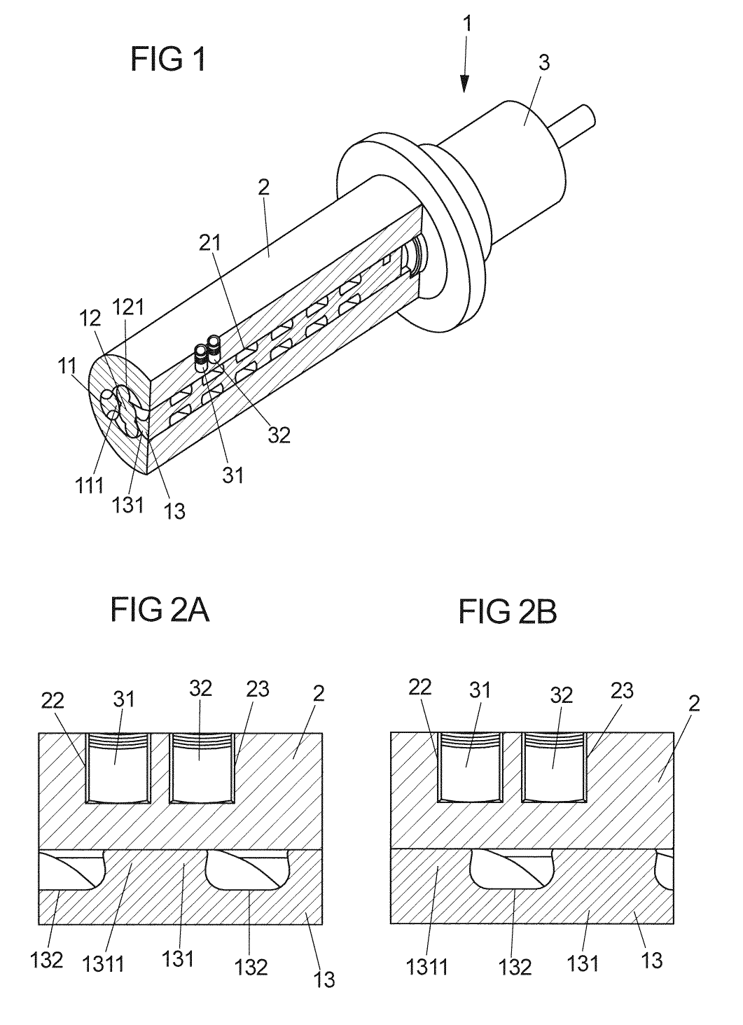

The gear pump, shown in FIG. 1, in the form of a screw-spindle pump 1 has three rotatable elements in the form of three threaded spindles 11-13 which rotate in opposite directions, wherein the screw-spindle pump 1 is illustrated in a sectioned manner in the region of one (the spindle 13) of the two outer spindles in order to show details of the interior of the screw-spindle pump 1. The spindles 11-13 each have a toothing system in the form of an outer thread-like profile 111, 121, 131, wherein the profiles 111, 131 of the outer spindles 11, 13 each interact with the profile 121 of the central spindle 12. Cavities (conveying chambers) into which the pumping medium is transported are created between the profiles 111, 131 of the outer spindles 11, 13 and the profile 121 of the central spindle 12. The spindles 11-13 (at least the central spindle 12) are driven, for example, by way of an electric motor 3. However, the principle of a screw-spindle pump of this kind is known per se.

The spindles 11-13 are accommodated in a housing 2 of the screw-spindle pump 1, wherein an inner side 21 of the housing 2 delimits the conveying chambers which are formed between the profiles 111, 121, 131 of the spindles 11-13. A transmitter 31 for exciting acoustic sound waves in the housing 2 and a receiver 32 for receiving the sound waves which are excited in the housing 2 are arranged in bores 22, 23 (also see FIGS. 2A and 2B) in the housing 2.

According to FIG. 1, the receiver 31 and the transmitter 32 are associated with the outer spindle 13, wherein they are arranged one behind the other along the rotation axis of the spindle 13. In this case, the transmitter and the receiver 31, 32 are oriented in the same vertical radial direction with respect to the spindle 13, that is to say their main emitting or receiving direction runs perpendicular in relation to a plane in which the rotation axes of the spindles 11-13 lie. A different orientation of the transmitter and of the receiver 31, 32, for example horizontal, is of course also feasible.

It is of course also possible that the transmitter the receiver 31, 32 is associated with one of the two other spindles 11, 12. In addition, it is feasible that there are a plurality of transmitters and receivers, wherein in each case one transmitter/receiver pair (one sensor) is associated with one spindle. By way of example, there are three transmitter/receiver pairs, of which in each case one pair is associated with one of the spindles 11 to 13. It is also feasible, for example, that only one transmitter but a plurality of receivers are used.

On the basis of the signal which is generated by the receiver 31 when the sound waves propagating in the housing 2 are received, information about properties of the screw-spindle pump 1 and/or about the conveyed pumping medium can be determined. In particular, surface sound waves (for example in the form of Lamb waves) are excited in the housing 2, which waves propagate at least partially on the inner side 21 of the housing 2, which inner side faces the spindles 11-13.

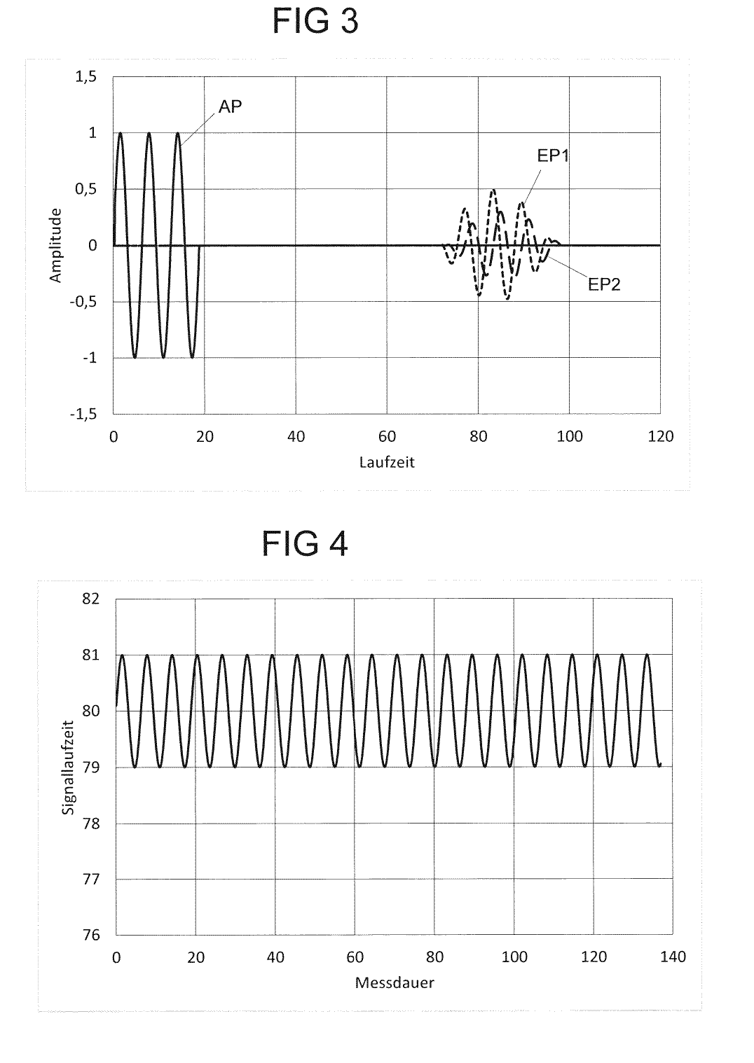

The propagation of surface sound waves of this kind depends on the condition of the inner side 21 of the housing 2 and the area surrounding the inner side 21. Therefore, the sound waves propagating along the inner side 21 are influenced by the material adjoining the inner side 21 of the housing 2. For example, the speed and the amplitude with which the sound waves propagate depend on the type of material which adjoins the inner side 21. In particular, the surface sound waves will propagate more rapidly when a raised portion 1311 (for example a peak) of the threaded profile 131 of the spindle 13 adjoins that region of the inner side 21 which is passed by the surface sound waves (that is to say adjoins the measurement section) (FIG. 2A) than in the case of a conveying chamber 132 (that is to say the pumping medium) predominantly adjoining there (FIG. 2B). Therefore, the propagation time of the acoustic waves changes depending on the position of the spindle 13, so that the propagation times periodically change during operation of the screw-spindle pump 1 (see FIG. 3).

Furthermore, a larger portion of the surface sound waves can decouple from the housing 2 when the pumping medium adjoins the inner side 21 (at that region of the inner side 21 that is crossed by the sound waves). Therefore, the amplitude of the receiver signal can also depend on the material present on the inner side 21. Accordingly, the amplitude of the receiver signal can also periodically fluctuate during operation of the screw-spindle pump 1.

The acoustic measurement section (the region between the transmitter 31 and the receiver 32) can be considered a multilayer system which is made up of a region of the housing 2 (in particular comprising the inner side 21), a lubricating film between the spindle 13 and the housing 2 and also a section of the spindle 13. The speed of the acoustic surface waves which propagate in this multilayer system depends, as mentioned above, on the composition of the layer system; see FIGS. 2A and 2B already mentioned above which illustrate the two extreme cases, specifically that the layer system has a thick metal layer (region 1311 of the spindle 13) (FIG. 2A) or comprises a thick layer which is formed from the pumping medium (FIG. 2B).

FIG. 3 illustrates the influence of the rotation of the spindle 13 on the propagation period and the amplitude of acoustic pulses AP which have been excited in the housing 2 and in particular its inner side 21 with the aid of the transmitter 31. According to said figure, an acoustic pulse runs more rapidly from the transmitter 31 to the receiver 32 when a raised portion 1311 of the threaded profile 131 of the spindle 13 adjoins the inner side 21 (receiver signal EP1) than in the case that one of the conveying chambers 132 (that is to say the pumping medium) is located there (receiver signal EP2). Therefore, periodic fluctuations in the propagation times are created during operation of the screw-spindle pump 1.

In order to detect these periodic fluctuations in the propagation times, for example continuously acoustic pulses are emitted and the propagation times of the pulses from the transmitter 31 to the receiver 32 are determined in each case. These ascertained propagation times (signal propagation times) are plotted against time (measurement period) (see FIG. 4) and evaluated. In particular, information about the state of the screw-spindle pump 1 and/or about the state of the pumping medium can be obtained from the periodic profile of the propagation times. Analogously, amplitudes of the pulses can also be ascertained and the (likewise periodic) profile of the pulse amplitudes can be evaluated for determining information about the state of the screw-spindle pump 1 and/or about the pumping medium.

For example, the spindle frequency can be determined from the frequency of the profile of the propagation times (“propagation time measurement signal”) shown in FIG. 4. In addition, the average value of the propagation time measurement signal is correlated with the speed of sound in the pumping medium. Furthermore, information about the quantity of the pumping medium can also be derived since the amplitude of the propagation time measurement signal depends on the quantity of the pumping medium. For example, the propagation times will change only slightly (that is to say the amplitude of the propagation time measurement signal decreases) if only a small quantity of the pumping medium is conveyed. Accordingly, dry-running or a threat of dry-running of the pump can be identified.

It is also feasible that it is possible to detect when the carrying lubricating film between the profiles of the spindle and the housing is so thin that contact at least occasionally occurs between the (metal) profile of the spindle and the inner side of the housing. In this case, a further metal region (of the profile of the spindle) would adjoin the inner side of the housing, as a result of which the speed of the surface sound waves changes, this causing a dip in the propagation time measurement signal. Dips of this kind occur more frequently the lower and more inhomogeneous the lubricating film.

Furthermore, inclusions (for example gas bubbles) in the pumping medium or other inhomogeneities in the pumping medium can also be noticeable in the measurement signal and can therefore be detected using the above method.

FIG. 5 concerns a modification to the screw-spindle pump from FIG. 1. Although the transmitter 31 and the receiver 32 are likewise associated with the spindle 13 and arranged axially one behind the other along the rotation axis of the spindle 13 here, the transmitter and the receiver 31, 32 are positioned at a greater distance in relation to one another. For example, the distance amounts to at least half the pitch of the external profile of the spindle 13.

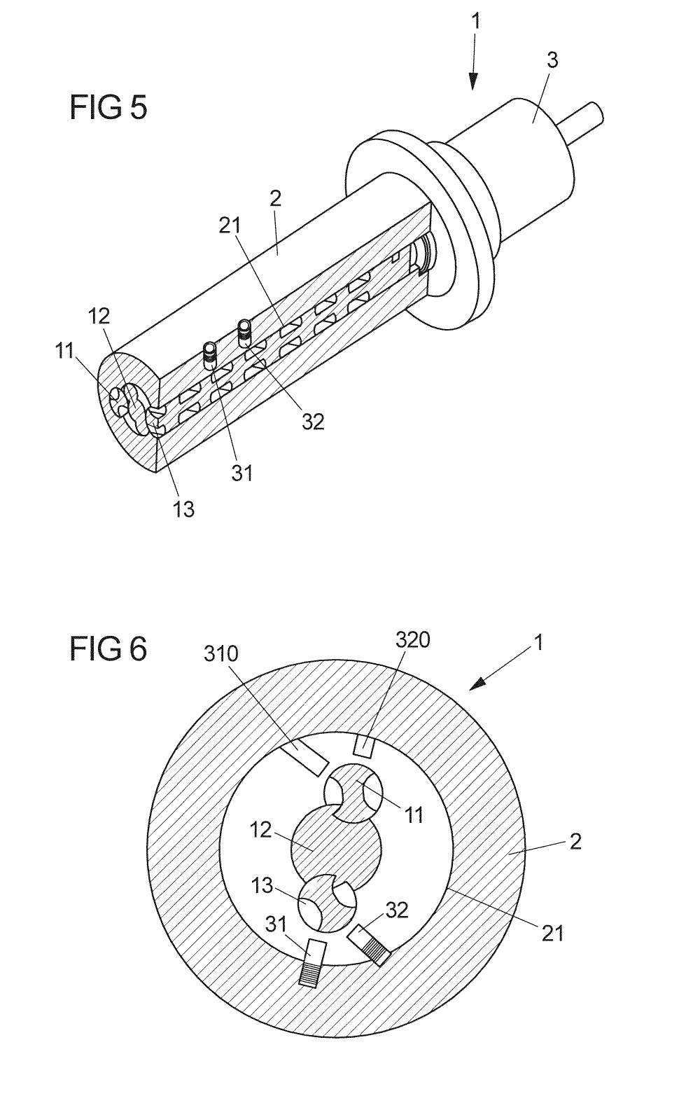

It is also feasible that the transmitter and the receiver 31, 32 are not arranged axially, but rather radially. In this case, the transmitter 31 and the receiver 32 are likewise associated with one of the spindles 11-13, wherein, however, they are each oriented along different radial directions with respect to the spindle. This is shown in FIG. 6. In said figure, the transmitter 31 is oriented along a first radial direction with respect to the spindle 13, and the receiver 32 is oriented along a second radial direction, which differs from the first radial direction. Furthermore, a transmitter 310 and a receiver 320, which are each likewise oriented radially, are also associated with the other outer spindle 11.

It should be noted that elements of the above-described exemplary embodiments can of course be used in combination with one another too. Therefore, a combination comprising an axial and a radial arrangement of the transmitter and the receiver on one and the same spindle can be realized for all intents and purposes. For example, a first, axially arranged transmitter/receiver pair can be associated with the outer spindle 13, and a second, radially oriented transmitter/receiver pair can be associated with the other outer spindle 11.

1. A gear pump comprising:
at least a first and a second rotatable element, wherein:
the first rotatable element has a toothing system which interacts with a toothing system of the second rotatable element;
a housing in which the first and/or the second rotatable element are at least partially arranged, and
at least one transmitter, which is arranged on the housing, for exciting acoustic waves in the housing and also at least one receiver, which is arranged on the housing, for receiving the acoustic waves which are excited in the housing, wherein information about properties of the gear pump and/or of a pumping medium can be determined by evaluating a signal which is generated by the receiver when the acoustic waves are received.

2. The gear pump as claimed in claim 1, wherein the toothing systems of the first and of the second rotatable element run obliquely in relation to the rotation axis of the respective rotatable element.

3. The gear pump as claimed in claim 2, wherein the gear pump is a screw-spindle pump, wherein the toothing systems of the first and of the second rotatable element are each designed in the form of a threaded profile.

4. The gear pump as claimed in claim 2, wherein the transmitter and the receiver are arranged at a distance from one another which amounts to at most half the pitch of the toothing system of the first or of the second rotatable element.

5. The gear pump as claimed in claim 2, the transmitter and the receiver are arranged at a distance from one another which amounts to at least half the pitch of the toothing system of the first or of the second rotatable element.

6. The gear pump as claimed in claim 1, wherein the transmitter and the receiver are arranged along a line which runs parallel in relation to the rotation axis of the first or of the second rotatable element.

7. The gear pump as claimed in claim 4, wherein the transmitter is oriented in a first radial direction and the receiver is oriented in a second radial direction, which differs from the first radial direction, either with respect to the first rotatable element or with respect to the second rotatable element.

8. A method for monitoring a gear pump, comprising:
providing at least a first and a second rotatable element, wherein the first rotatable element has a toothing system which interacts with a toothing system of the second rotatable element, and wherein the first and/or the second rotatable element are at least partially arranged in a housing; and
exciting acoustic waves in the housing by way of at least one transmitter which is arranged on the housing, and receiving the acoustic waves, which are excited in the housing, by way of a receiver which is arranged on the housing, and also determining information about properties of the gear pump and/or of a pumping medium by evaluating a signal which is generated by the receiver when the acoustic waves are received.

9. The method as claimed in claim 8, wherein information relating to a lubricating film, a load which acts on the first and/or second rotatable element and/or a movement of the first or of the second rotatable element, are determined and/or a defect in the first or in the second rotatable element is detected by evaluating the signal from the receiver during operation of the gear pump.

10. The method as claimed in claim 8, wherein evaluating the signal from the receiver comprises evaluating an amplitude, a frequency spectrum and/or an envelope of the signal and/or of a time interval of structures in the signal.

11. The method as claimed in claim 8, wherein evaluating the signal from the receiver comprises identifying patterns in the profile of the receiver signal.

12. The method as claimed in claim 8, wherein pulsed acoustic waves are excited in the housing, wherein evaluating the receiver signal comprises ascertaining propagation times and/or amplitudes of the pulsed acoustic waves during operation of the gear pump.

13. The method as claimed in claim 12, wherein the propagation times and/or the amplitudes periodically fluctuate during operation of the gear pump, wherein the information about properties of the gear pump and/or the pumping medium are ascertained on the basis of the amplitude of the fluctuations in the propagation times.
